(19) United States
(12) Patent Application Publication
(10) Pub. No.: US 2026/0201857 A1
(43) Pub. Date: Jul. 16, 2026

(54) FLEXIBLE FUEL ENGINE ENABLED BY HYDROGEN

(71) Applicant: Blaze Energy Technologies Corporation, Wheat Ridge, CO (US)

(72) Inventors: Jesse E. Hensley, Arvada, CO (US); Richard D. Barton, Arvada, CO (US); Rok Sitar, Los Alamos, NM (US)

(21) Appl. No.: 19/442,566

(22) Filed: Jan. 7, 2026

Related U.S. Application Data
(60) Provisional application No. 63/744,667, filed on Jan. 13, 2025.

(51) Int. Cl. F02M 25/12; F02M 21/02

(52) U.S. Cl. CPC F02M 25/12; F02M 21/0206

(57) ABSTRACT

An apparatus and method to allow flexible fueling of engines (including but not limited to four cycle compression ignition engines) with a portion of hydrogen gas derived “on demand” from a fluid containing chemically-bound hydrogen. The use of multiple fuel types including compressed or liquefied natural gas, diesel, heavy fuel oil, methanol, liquefied petroleum gas, and liquefied ammonia is enabled by modifying their combustion behavior with this derived hydrogen gas. Existing engines can optionally be enabled through a retrofit that adds the aforementioned apparatus, injecting the produced hydrogen gas into the air intake of the engine.

### CROSS-REFERENCE TO RELATED APPLICATIONS

This application claims priority to and the benefit of the filing of U.S. Provisional Patent Application No. 63/744,667, entitled “Flexible Fuel Engine Enabled By Ammonia”, filed on Jan. 13, 2025, and the specification thereof is incorporated herein by reference.

### STATEMENT REGARDING FEDERALLY SPONSORED RESEARCH OR DEVELOPMENT

Not applicable.

### BACKGROUND OF THE INVENTION

Embodiments of the present invention relate to catalytic thermal reforming (also known as cracking) to liberate hydrogen gas (“H2”) on demand (also referred to herein as “producing” the hydrogen gas) and the operation of engines fueled in part by this H2 to improve engine efficiency and reduce emissions. When the addition of H2 results in efficiency improvements in the engine and/or when the H2 is derived from a low-carbon or zero-carbon source, embodiments of the present invention provide an efficient and economic method and apparatus that reduces carbon dioxide (“CO2”) emissions.

Energy sources that are substantially free of CO2 emissions are highly sought after in both developed and developing countries. Carbon-free energy for difficult to abate sectors including heavy equipment and maritime shipping is especially needed. Heavy equipment and ships most often generate motive power through the combustion of fuels in compression engines.

H2 is known to improve the speed and temperature of combustion of alternative fuels that can reduce or eliminate greenhouse gas emissions from an internal combustion engine—particularly from a compression ignition engine (“CIE”) (including but not limited to those that are used in heavy equipment and ships). Exemplary alternative fuels include natural gas and ammonia, but both experience incomplete combustion in engines—especially those designed for more traditional fuels for heavy equipment and ships, including, for example, diesel. Because H2 combusts with a higher flame speed than other fuels, it helps to fully consume fuels that combust more slowly, resulting in more energy released from the fuels and fewer combustion byproducts (which would otherwise result from incomplete combustion) that lead to pollution and the need for complex exhaust treatment systems. The use of H2 as a supplemental or “flex” fuel is therefore desired, however, H2 is difficult and expensive to store and transport and its density in stored form, inclusive of necessary tanks and equipment, renders it impossible to use continuously in applications like heavy equipment, marine shipping, air travel, and locomotives. Embodiments of the present invention provide an efficient and economic method and apparatus to derive and use H2 from fluids that can be stored and transported in sufficient mass and in a small enough volume to enable continuous use of H2 in engines—including but not limited to those used in large, mobile, and energy-intensive applications.

### BRIEF SUMMARY OF EMBODIMENTS OF THE PRESENT INVENTION

Embodiments of the present invention relate to a flex fueling apparatus having a fluid container, a heat exchanger communicably coupled to the fluid container and configured to increase a temperature of a fluid containing chemically-bound hydrogen by using a fluid from a system associated with an engine, a catalytic reformer in fluid communication with the fluid container, the catalytic reformer comprising a solid phase catalyst selected to reform the fluid containing chemically-bound hydrogen and liberate the hydrogen, a heater positioned to supply heat to an endothermic reforming reaction that liberates the hydrogen from the fluid containing chemically-bound hydrogen, a source of energy, a controller configured to control the heater, electromechanical hardware configured to adjust or control a flow of the liberated hydrogen that is produced by the catalytic reformer; and an electromechanical apparatus configured to control a flow of the liberated hydrogen to an air intake system of an engine. The heater can include an electrical heater and wherein the source of energy comprises a source of electrical power and wherein the controller is configured to control power delivered to the electrical heater. The flex fueling apparatus can also include at least some of the fluid containing chemically-bound hydrogen disposed within the fluid container, and the fluid containing chemically-bound hydrogen can be at least ninety percent by weight of any of ammonia, urea, methanol, ethanol, natural gas, and/or a combination thereof. The heat exchanger can be further communicably coupled to at least one of an engine coolant system, an engine exhaust system, and/or a reformer effluent system. The heater can be positioned to physically contact the fluid containing chemically-bound hydrogen and to physically contact the liberated hydrogen gas.

In one embodiment, an electrical heater can be communicably coupled to a single phase alternating current source and/or a three-phase alternating current source. The controller can be configured to reduce a voltage of the single phase alternating current source and/or the three-phase alternating current source. The flex fueling apparatus can also include a battery and/or capacitor coupled and configured to store electrical power and the controller can be configured to control power delivered to the electrical heater from the battery and/or capacitor. In one embodiment the electromechanical hardware can include a combination of at least four elements selected from: a shutoff valve configured to turn on and/or off a flow of the fluid containing chemically-bound hydrogen, a pump configured to increase the flow and/or a pressure of the fluid containing chemically-bound hydrogen to the catalytic reformer, a control valve configured to increase or decrease the flow of the fluid containing chemically-bound hydrogen to the catalytic reformer, a shutoff valve configured to allow and/or disallow a flow of inert gas into the fluid container, a pressure sensor positioned to sense a pressure of the liberated hydrogen, a composition sensor configured to sense a fraction of hydrogen gas contained in fluid exiting the catalytic reformer, a composition sensor configured to sense a fraction of fluid containing chemically-bound hydrogen remaining in the fluid exiting the catalytic reformer, and/or an accumulation volume sensor that determines an accumulation volume of the liberated hydrogen, which accumulation volume does not include the liberated hydrogen that has already been withdrawn therefrom for delivery to the engine.

Embodiments of the present invention relate to a method of retrofitting an engine to allow flex fueling with a portion of hydrogen gas including installing a container designated for fluid containing chemically-bound hydrogen, a heat exchanger configured to increase a temperature of the fluid containing chemically-bound hydrogen, the heat exchanger coupled to receive a fluid from a system associated with the engine, a catalytic reformer configured to liberate hydrogen gas from fluid containing chemically-bound hydrogen, a heater configured to supply heat to an endothermic reforming reaction that liberates the hydrogen gas from the fluid containing chemically-bound hydrogen, a controller configured to control the heater, a control computer configured to receive input signals and send output signals to control devices, a wire connected to an output terminal of the control computer, electromechanical hardware to control a flow of the liberated hydrogen gas from the catalytic reformer, and an electromechanical apparatus, the electromechanical apparatus configured to periodically and/or adjustably allow a flow of the hydrogen gas to enter an air intake system of the engine. Optionally, installing the heater can include installing an electrical heater and installing the controller can include installing a power controller configured to control power delivered to the electrical heater.

Embodiments of the present invention also relate to a method for providing supplemental hydrogen to assist combustion of another fuel in an engine, the method including providing a supply of a fluid containing a chemically-bound hydrogen from a storage tank, pre-heating the fluid containing a chemically-bound hydrogen with a heat exchanger, the heat exchanger coupled and configured to receive a flow of an engine system fluid having a temperature greater than an internal temperature of the storage tank, providing heat from a heater to an endothermic reforming reaction that liberates the hydrogen from the fluid containing chemically-bound hydrogen, passing the pre-heated fluid containing a chemically-bound hydrogen into a catalytic reformer, such that the fluid containing a chemically-bound hydrogen contacts a catalyst and reforms the fluid containing a chemically-bound hydrogen to liberate hydrogen gas, collecting the liberated hydrogen gas, and dynamically controlling a flow of the liberated hydrogen gas into an air intake system of the engine. Optionally, providing heat from a heater can include providing heat from an electrical heater. The method can also include dynamically controlling the liberation of hydrogen gas by a combination of at least three elements selected from the following: turning on and/or off a flow of the fluid containing the chemically-bound hydrogen with a shutoff valve, increasing the flow and/or a pressure of the fluid containing a chemically-bound hydrogen to the catalytic reformer with a pump, adjusting the flow of the fluid containing chemically-bound hydrogen to the catalytic reformer, using a shutoff valve to allow and/or disallow a flow of inert gas into the fluid container, using a pressure sensor to sense a pressure of the liberated hydrogen, sensing a fraction of hydrogen gas contained in fluid exiting the catalytic reformer, sensing a fraction of the fluid containing chemically-bound hydrogen remaining after exiting the catalytic reformer, and/or determining an accumulation volume of the liberated hydrogen, which accumulation volume does not include the liberated hydrogen that has already been withdrawn therefrom for delivery to the engine.

In one embodiment, providing heat from a heater to an endothermic reforming reaction can include further heating the fluid with the heater. Providing heat from the heater can include providing heat from a heater which is powered by a source that does not include the engine. Providing heat from a heater can include providing heat from an alternating current electrical heater which is powered by a generator, which can optionally be a single phase generator and/or a 3-phase generator. Providing a supply of a fluid containing a chemically-bound hydrogen can include providing a liquid supply of the fluid containing a chemically-bound hydrogen from the storage tank. Optionally, the method can also include heating to vaporize the liquid supply the fluid containing a chemically-bound hydrogen before the step of pre-heating the fluid containing a chemically-bound hydrogen with a heat exchanger. Heating to vaporize can include heating to vaporize with a vaporizing heat exchanger that receives heat energy produced by the engine. The heat produced by the engine can include heat from an exhaust of the engine.

In one embodiment, providing heat from a heater can include providing heat from a direct-current electrically-powered heater and the direct-current can be stored in a battery and/or a capacitor. The battery and/or capacitor can receive electrical energy that is produced by an alternator or generator that is part of or is otherwise coupled to the engine. Optionally, providing a supply of a fluid containing a chemically-bound hydrogen from a storage tank can include providing a supply of ammonia. Dynamically controlling a flow of the liberated hydrogen gas can include dynamically controlling based on a load on the engine.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIG. 1 is a drawing which illustrates an example of a four cycle compression ignition engine (CIE) of an embodiment of the present invention having an air intake pipe or manifold, compression/combustion cylinder, power transfer piston and piston arm, liquid injector (direct injector), gas injectors (port injectors), gas mixer, intake and exhaust valves, exhaust pipe or manifold, ammonia (NH₃) catalytic reformer, hydrogen (H₂) sensor, oxygen (O₂) sensor, and air pressure sensor;

FIG. 2A is a drawing of the four cycle CIE of FIG. 1 which is in a first cycle of operation;

FIG. 2B is a drawing of the four cycle CIE of FIG. 1 which is at the end of its first cycle of operation;

FIG. 3A is a drawing of the four cycle CIE of FIG. 1 which is in its second cycle of operation;

FIG. 3B is a drawing of the four cycle CIE of FIG. 1 which is at the point of ignition between the second and third cycle of operation;

FIG. 4 is a drawing of the four cycle CIE of FIG. 1 which is in its third cycle of operation;

FIG. 5A is a drawing of the four cycle CIE of FIG. 1 which is beginning its fourth cycle of operation;

FIG. 5B is a drawing of the four cycle CIE of FIG. 1 which is in its fourth cycle of operation;

FIG. 6 is a drawing which illustrates the use of exhaust gas recirculation which can be added to the CIE of FIGS. 1-5B;

FIG. 7A is a drawing which illustrates a catalytic reformer that is heated by CIE exhaust;

FIG. 7B is a drawing which illustrates an embodiment of a catalytic reformer heated by CIE exhaust and wherein a combustible liquid with chemically-bound hydrogen is vaporized using heat from the CIE block;

FIG. 7C is a drawing which illustrates an embodiment of a catalytic reformer heated by CIE exhaust and wherein a combustible liquid with chemically-bound hydrogen is vaporized using heat from the CIE cooling system;

FIG. 8A is a drawing which illustrates a catalytic reformer according to an embodiment of the present invention which is heated by electrical energy derived from an alternator powered by the CIE and wherein a combustible liquid with chemically-bound hydrogen is preheated and vaporized using heat from the CIE exhaust;

FIG. 8B is a drawing which illustrates an example configuration of a catalytic reformer that is heated by electrical energy derived from an alternator powered by the CIE, and wherein a combustible liquid with chemically-bound hydrogen is preheated using heat from the CIE exhaust, and wherein a combustible liquid with chemically-bound hydrogen is vaporized using heat from the CIE block, according to an embodiment of the present invention;

FIG. 8C is a drawing which illustrates an example configuration of a catalytic reformer that is heated by electrical energy derived from an alternator powered by the CIE, and wherein a combustible liquid with chemically-bound hydrogen is preheated using heat from the CIE exhaust, and wherein a combustible liquid with chemically-bound hydrogen is vaporized using heat from the CIE cooling system;

FIG. 8D is a drawing which illustrates an example configuration of a catalytic reformer that is heated by electrical energy supplied from a source other than the CIE;

FIG. 9 is a chart which illustrates connections between sensor inputs and controlled outputs according to an embodiment of the present invention;

FIG. 10 is a block diagram illustrating an example computer system that can be used in an embodiment of the present invention; and

FIG. 11 is a drawing which illustrates an apparatus that can be added to an engine as a retrofit to provide H2 derived from a combustible liquid with chemically-bound hydrogen to improve engine performance.

### DETAILED DESCRIPTION OF THE INVENTION

Embodiments are described more fully below with reference to the accompanying figures, which form a part hereof and show, by way of illustration, specific exemplary embodiments. These embodiments are disclosed in sufficient detail to enable those skilled in the art to practice the disclosed embodiments. However, embodiments can be implemented in many different forms and should not be construed as being limited to the embodiments set forth herein. The following detailed description is, therefore, not to be construed as limiting the invention.

Hard-to-abate energy sectors such as maritime shipping and transport, airplanes, power

generating turbines, large stationary generators, and heavy equipment have been seeking methods to reduce their production of carbon dioxide (CO2) emissions via electrification, efficiency improvements, carbon capture and sequestration, and alternative fuels with lower carbon emissions per unit of useful work delivered. Carbon-free or carbon-neutral fuels are of special interest because if produced using renewable methods, can allow the use of existing power delivery systems and infrastructure while achieving substantially reduced CO2 emissions.

Ammonia (NH3) is a carbon-free molecule that can be combusted as a fuel according to the exothermic reaction (1):

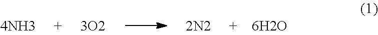

NH3 can also be used as a hydrogen (H2) carrier. When heated in the presence of a reforming catalyst, NH3 decomposes to H2 and N2 according to the endothermic reaction (2):

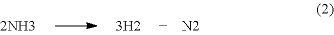

H2 can similarly be combusted as a fuel according to the exothermic reaction (3):

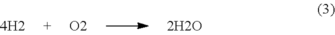

Thus, NH3 or its derivative H2 could be used as a fuel in engines for hard-to-abate sectors.

Methanol (“CH3OH”) is an alcohol that can be produced from waste material, biomass, and/or CO2 along with its traditional production from natural gas. CH3OH can be combusted as a fuel according to the exothermic reaction (4):

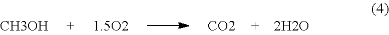

CH3OH can also be used as an H2 carrier. When heated in the presence of a reforming catalyst, CH3OH decomposes to H2 and carbon monoxide (“CO”) according to the endothermic reaction (5):

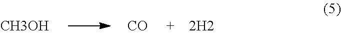

In the presence of water, CO can also undergo the water gas shift reaction to produce more H2 and byproduct CO2 according to reversible reaction (6):

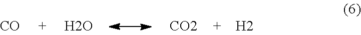

CO can also be combusted according to the exothermic reaction (7):

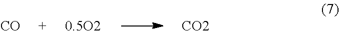

Thus, CH3OH or its derivatives H2 or CO can be used as fuel in engines. Similarly, a portion of CH3OH mixed with a second portion of its derivatives H2 and/or CO can be used as fuel in engines.

Methane (CH4) is a hydrocarbon that can be produced through biological breakdown of wastes or through hydrogenation of captured CO2, along with its production in natural gas. CH4 can be combusted as a fuel according to the exothermic reaction (8):

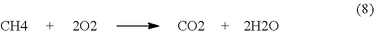

CH4 can also be used as an H2 carrier. When heated in the presence of a reforming catalyst and H2O, CH4 reforms according to the endothermic reaction (9):

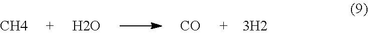

When partially oxidized in the presence of a partial oxidation catalyst and O2, CH4 reforms according to exothermic reaction (10):

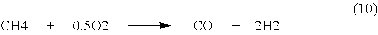

In the presence of water, CO from this reaction can also undergo the water gas shift reaction (6), and in the presence of O2, CO can also undergo combustion according to reaction (7).
Thus, CH4 or its derivatives H2 or CO can be used as fuel in engines. Similarly, a portion of CH4 mixed with a second portion of its derivatives H2 and/or CO can be used as fuel in engines.

Other chemicals and hydrocarbons can similarly be used as fuels and can be catalytically reformed to produce H2 using similar methods.

A portion of a fuel mixed with a portion of H2 and/or CO derived from NH3, CH3OH, CH4, or any other chemical or hydrocarbon, can be used as fuel in engines.

Many of the power plants for hard-to-abate sectors rely on engines, including CIEs and spark ignition engines (“SIEs”) to extract useful work from liquid and gaseous fuels, including four cycle CIEs, two cycle CIEs, four cycle SIEs, two cycle SIEs, and turbofan engines. Therefore, the useful operation of engines on carbon-free fuels including NH3 and H2 and/or reduced carbon fuels like CH3OH and CH4 is desired.

In the detailed description that follows, the operation of CIEs and the advantages of adding H2 to the air intake of the engine are described. The addition of H2 to the air intake of the engine is advantageous whether traditional or alternative fuels are used. The addition of H2 to the air intake of the engine is also advantageous whether the primary fuel is added directly into the engine combustion zone (i.e., direct fuel injection) or to the engine intake air (i.e., indirect or port fuel injection). NH3 is an example of a material that can be used as both an alternative fuel and an H2 source, but it should be appreciated that any fluid containing chemically-bound hydrogen can be used as the H2 source and any combustible fluid can be used as the fuel that is combusted with H2 in the engine's combustion chamber. In one embodiment, the fluid containing chemically-bound hydrogen can be a combustible fluid containing chemically-bound hydrogen—particularly when the fluid is vaporized. Similarly, while the operation of a four cycle CIE is referenced throughout this application, to be clear, this is done only for illustrative purposes and embodiments of the present invention can be used with a SIE and/or turbofan engine, including but not limited to 2-cycle, 4-cycle, and rotary engines.

CIEs (including for example four cycle CIEs) operate by filling a cylindrical combustion chamber with air that is introduced through an open intake valve, and fuel that is introduced directly into the chamber through an injector nozzle (direct injection) or into the flowing air stream prior to entering the chamber (port injection or more generally, indirect injection). Once the chamber has received fuel and air, the air intake valve closes, and the air/fuel mixture is compressed with an upward-traveling piston connected to a drive shaft. The compression causes the mixture to heat rapidly to the point of autoignition, at which point the fuel is combusted, expanding rapidly and forcing the piston downward, transferring work to the drive shaft. Finally, an exhaust valve is opened and the piston travels back upward, expelling combustion products from the combustion chamber. The exhaust valve closes, the air intake valve opens, and the cycle repeats. Therefore, a combustion cycle includes two compression events, two expansion events, one fuel delivery event, one ignition event, one power transfer event, and one regeneration event.

When NH3 is used as fuel, it can be difficult to ignite. The autoignition temperature of NH3 is 657° C., which is much higher than the autoignition temperature of traditional CIE fuels, such as diesel, which has an autoignition temperature of 254-285° C. Furthermore, when NH3 is ignited, it burns slower than many fuels. For instance, the flame speed, i.e., the speed at which a flame front propagates through a fuel vapor/air mixture, is about 7 cm/s, whereas diesel has a flame speed of 86 cm/s, approximately 12 times faster. This slower burning can be a problem because the fuel must be completely combusted between the time it is ignited and the time the exhaust valve is opened to clear the cylinder. If it is not, a portion of the fuel energy is wasted (not converted to work via gas expansion), and a portion of the fuel is exhausted from the engine, where it can lead to environmental pollution.

H2 can provide a solution to NH3's limitations by increasing the flame speed of the fuel mixture (351 cm/s for pure hydrogen) and decreasing the autoignition temperature (585° C. in air). H2 also has a higher adiabatic combustion temperature (2110° C. vs. 1800° C. for NH3) which can result in higher operating temperatures of the combustion chamber walls, resulting in less heat requirement from compression to reach autoignition temperature.

In a similar way, NH3 can be mixed with diesel to obtain a balance of combustion properties that result in efficient operation of a CIE, however, the amount of NH3 that can be used to displace carbon-containing fuels will be limited by its unfavorable combustion properties.

To maximize the amount of NH3 used as a fuel in the operation of a CIE, H2 can be blended with NH3 to improve combustion properties and thereby reduce the amount of carbon-containing fuel delivered to the CIE. However, H2 is difficult to store at large volumes without specialized and expensive equipment. Therefore, it is advantageous to reform a portion of the NH3 fuel (equation 2) to generate the desired H2 “on demand.”

The amount of H2 required for efficient combustion of NH3 will depend on several factors, including the compression ratio of the CIE (i.e., effective compression and achievable ignition temperature), speed of the engine (i.e., amount of time available to burn the fuel/air in the combustion chamber per cycle), presence of other fuels and their associated combustion properties (e.g., diesel or methanol), temperature and pressure of air at the intake valve (i.e., the amount of air/fuel blend that can be injected into the combustion chamber per cycle), and the load applied to the engine (i.e., the forces resisting the downward movement of the piston driven by combustion and gas expansion in the combustion chamber). Similar criteria will dictate the amount of H2 required for efficient combustion in spark ignited engines, 2-cycle engines, and turbofan engines. The forementioned will also influence the proper timing of fuel injection events and quantity of fuel injected (i.e., injector “on” time) per cycle.

In a similar way, the injection of H2 derived from reformed NH3 “on demand” can improve the combustion properties of other alternative CIE fuels such as natural gas and methanol, which have autoignition temperatures of 586° C. and 433° C., respectively, and flame speeds of 38 cm/s and 43 cm/s, respectively. That is, as with NH3, these fuels are also harder to ignite and burn slower than diesel.

Therefore, a method and apparatus are needed to deliver a stream of on-demand H2, derived from NH3 or any other energy-dense fluids with chemically-bound hydrogen, to enable the operation of CIEs with flex fuel capability. In one embodiment, this can include a catalytic converter to partially or completely reform NH3 or other energy-dense fluid with chemically-bound hydrogen, heat exchangers to vaporize and preheat the energy-dense fluid with chemically-bound hydrogen, a source of energy to maintain the reforming reaction in the catalytic converter, an H2 injection apparatus, an H2 measuring or metering apparatus (or measuring or metering apparatus for the fluid with chemically-bound hydrogen), a standalone or engine-integrated controller, one or more sensors to indicate the engine's demand for H2 at a given speed and load, and a control algorithm to adjust the amount of H2 delivered to the CIE.

Embodiments of the present invention relate to a method and apparatus to deliver on-demand H2, derived from NH3 or any other energy-dense fluid with chemically-bound hydrogen, to enable the operation of engines with flex fuel capability.

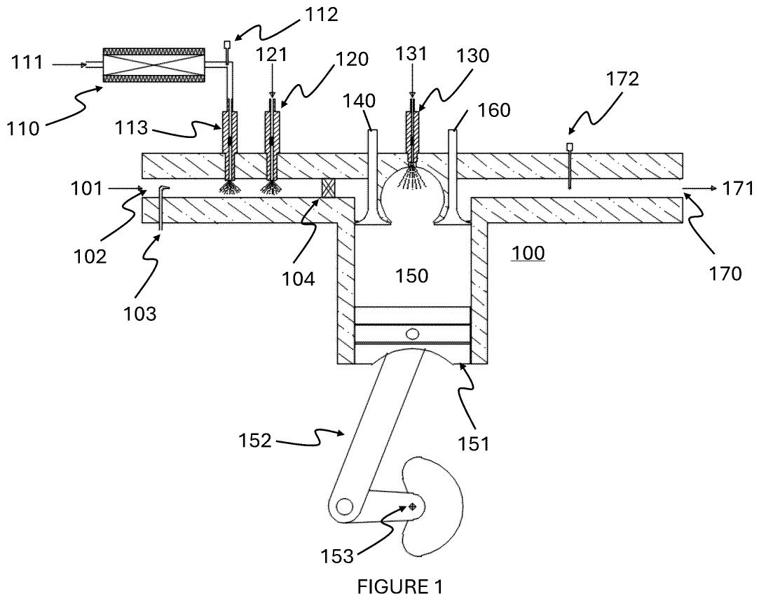

FIG. 1 is a schematic representation of a CIE equipped to generate power from various liquid fuels and H2 derived from NH3 according to an embodiment of the present invention. A cross section of engine block 100, having one or more combustion chambers, includes an air intake pipe or manifold 102, an exhaust pipe or manifold 170, combustion chamber 150 with piston 151, intake valve 140, exhaust valve 160, and fuel injectors 113, 120, and 130. During operation, air is introduced at inlet 101, drawn inward from the suction created by piston 151 downward movement (i.e., naturally aspirated) or pushed inward from a compressor (e.g., turbocharged or supercharged). The air temperature and pressure are measured at sensor 103, which can be placed upstream or downstream of fuel injectors, or at locations both upstream and downstream of injectors. An air flow sensor can also be included with sensor set 103. NH3 gas 111 is fed to reformer 110 where it is decomposed partially or fully to H2, the concentration of which is measured at sensor 112. In one embodiment, reformer 110 can be of a packed bed type (e.g., catalytic material comprising solid particles, extrudates, pellets, or agglomerates contained within a tube, pipe, or duct) or a monolith type (e.g. catalytic material deposited on the walls of a monolithic structure of ceramic or metallic construction). The catalyst used in the reformer can optionally be any type effective for the reforming of NH3 according to equation 2 (e.g., ruthenium, nickel, cobalt, alloys thereof, carbides or nitrides of nickel, cobalt, and/or molybdenum, with or without promoter metals including for example potassium, magnesium, and/or cesium). Although various operating temperatures can be used, in one embodiment, preferred operating temperatures for the reformer are those sufficient to activate the catalytic reaction of equation 2 (which can include for example temperatures and/or temperature ranges of from about 400 centigrade (° C.) to about 750° C.) with the lowest temperature that provides reliable operation of the reforming being most preferred. A gaseous stream containing H2, N2, and any unconverted NH3 is injected into the intake air at port injector 113. Additional liquid or gaseous fuel 121 can be injected into the intake air at port injector 120. Although reference is specifically made to NH3 111, it is to be understood that any other energy-dense fluid with chemically bound hydrogen can be used in place of NH3. This is also the case for any other teachings throughout this application where reference is specifically made to the use of NH3.

Injectors 113 and 120 can optionally be located very close to intake valve 140 or far upstream of valve 140 or at any position in between and can be in any order along the path of flowing air. Injector 120 can be operated with injector 113, by itself (no H2, e.g., during engine startup or high load), or not at all (i.e., all port injected fuel comprises NH3 and H2). An optional gas mixer 104 can be used to further mix intake air and fuel. H2 sensor 112 can be alternatively located in the intake pipe or manifold 102, downstream of injector 113, or injectors 113 and 120, or mixer 104. Liquid fuel 131 is injected directly into the combustion chamber via injector 130. Liquid fuel can comprise a broad range of the total fuel energy delivered to combustion chamber 150. For example, 10%, 30%, 50%, 70%, 90%, or any other amount less than 100% of the total fuel energy can be injected through injector 130. The liquid fuel can comprise any combustible fluid that can be ignited via compression or ignited via combustion heat from compression-ignited port fuel. For example, the fuel can comprise diesel, heavy fuel oil, methanol, liquified natural gas, liquefied petroleum gas, NH3, dimethyl ether, combinations of any of these, or other fuels not listed. The movement of piston 151 in combustion chamber 150 derives from the rotation of drive shaft 153, linked to piston 151 through piston rod 152. Exhaust gases are preferably received into exhaust pipe or manifold 170 with exhaust passing O2 sensor 172 and exhaust releasing to atmosphere via flow path 171 and/or recirculating in part to the intake manifold through exhaust gas recirculation (EGR) via flow path 173.

Although this application, and the figures, detail embodiments of the present invention that are used with compression ignition internal combustion engines, embodiments of the present invention can function, and provide desirable results, with combustion engines that are not initiated by compression alone. For example, embodiments of the present invention can be used with engines that rely on one or more spark plugs, or any other device or apparatus that relies on laser, plasma, microwave and/or corona discharge for ignition of the combustion mixture. Accordingly, when reference is made to CIE throughout this application, it should be understood that this can include engines of other forms of ignition.

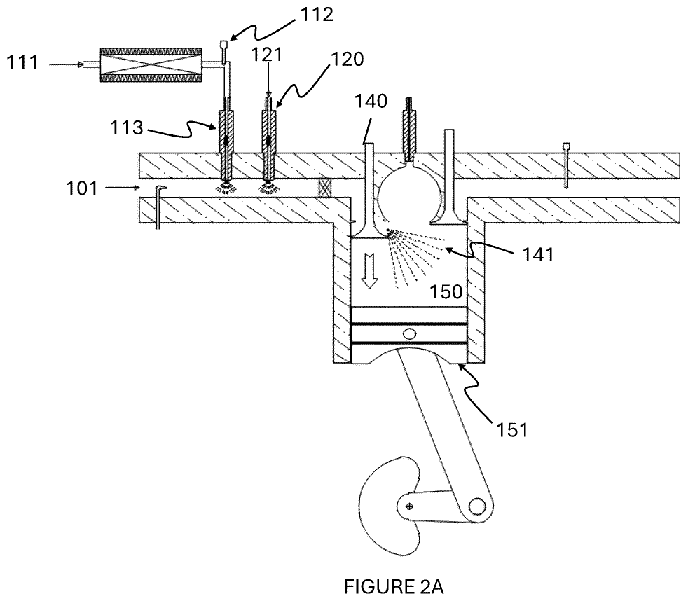

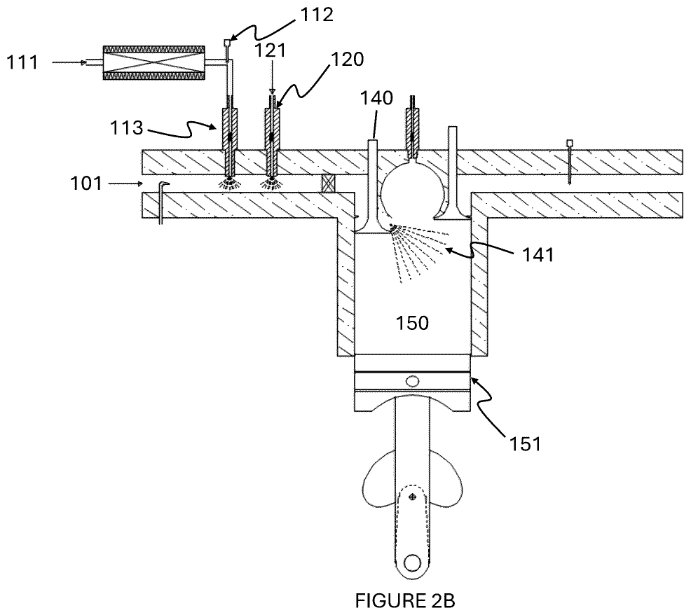

FIGS. 2A and 2B illustrate the first portion of the CIE cycle. Valve 140 opens and piston 151 moves downward in combustion chamber 150. NH3 111 is reformed to a mixture of H2 and NH3, with composition preferably measured by sensor 112, and injected into intake air through injector 113. Additional fuel 121 is optionally injected through injector 120. Air and fuel mixture 141 passes through open intake valve 140 into combustion chamber 150 until piston 151 reaches the bottom of its stroke as illustrated in FIG. 2B.

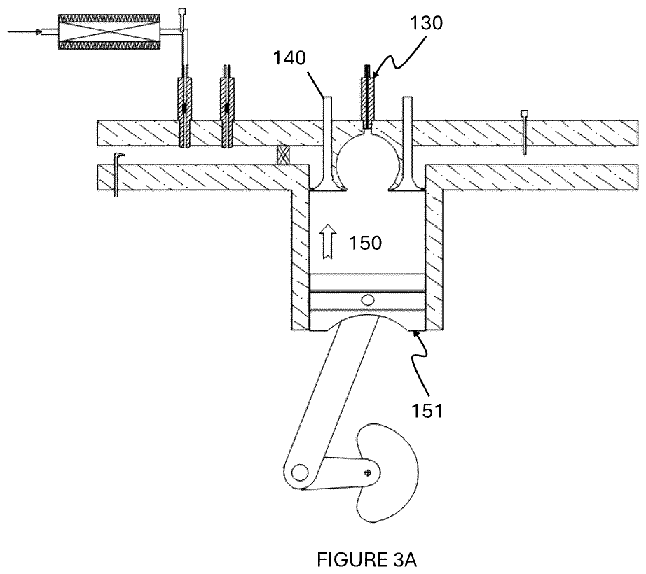

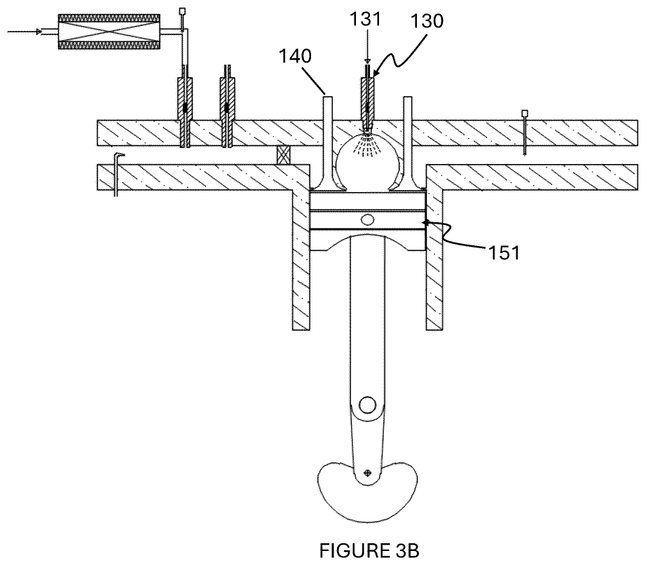

FIGS. 3A and 3B illustrate the second part of the CIE cycle. Valve 140 closes and piston 151 moves upward in combustion chamber 150, compressing air fuel mixture 141 from FIG. 2. As piston 151 nears the top of its stroke, additional liquid fuel 131 is optionally injected through injector 130.

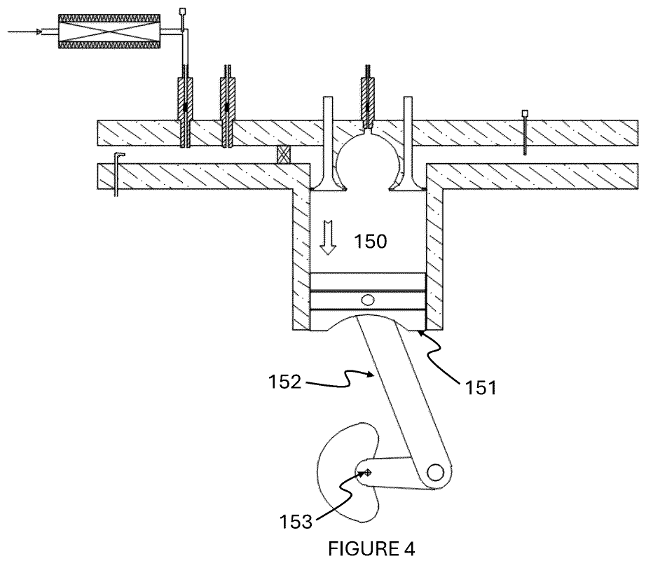

FIG. 4 illustrates the third part of the CIE cycle. Autoignition of fuel 131 from FIG. 3 and air and fuel mixture 141 from FIG. 2 occurs, releasing heat and expanding gases within combustion chamber 150, forcing piston 151 downward, delivering power to drive shaft 153 via piston rod 152.

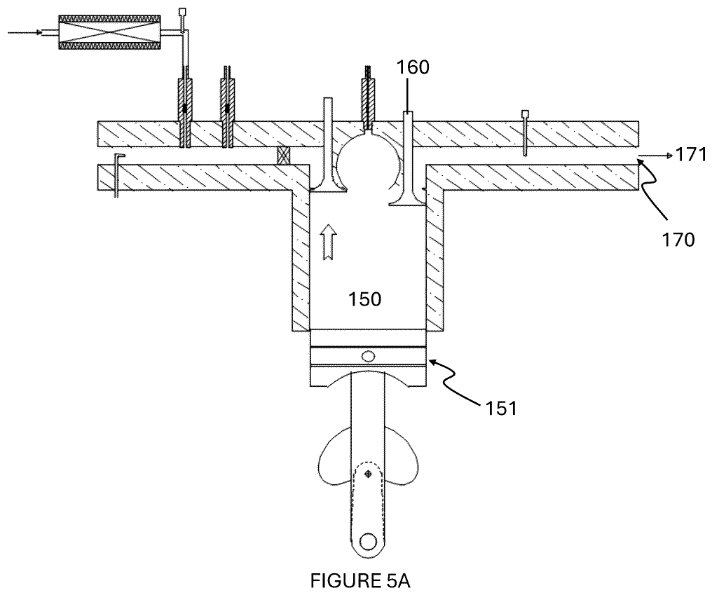

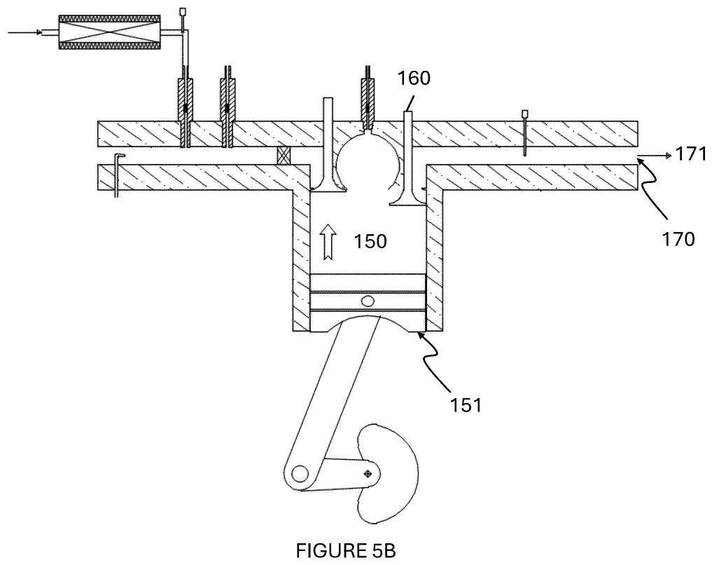

FIG. 5A and FIG. 5B illustrate the fourth part of the CIE cycle. Exhaust valve 160 opens and piston 151 travels upward through combustion chamber 150, expelling combustion products into exhaust pipe or manifold 170, releasing exhaust stream 171.

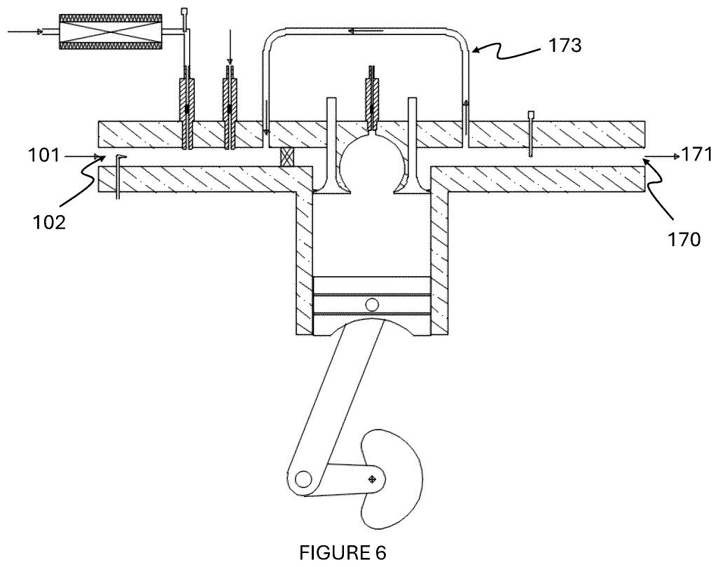

FIG. 6 illustrates an example of the use of EGR in CIE operation. A portion of exhaust stream 171 from pipe or manifold 170 is allowed to pass through pipe or conduit 173 and into air intake pipe or manifold 102. In this way, a portion of unconsumed O2, fuel, and combustion heat is transferred to air stream 101, ultimately incorporating into the fuel and air stream, e.g., mixture 141 in FIG. 2.

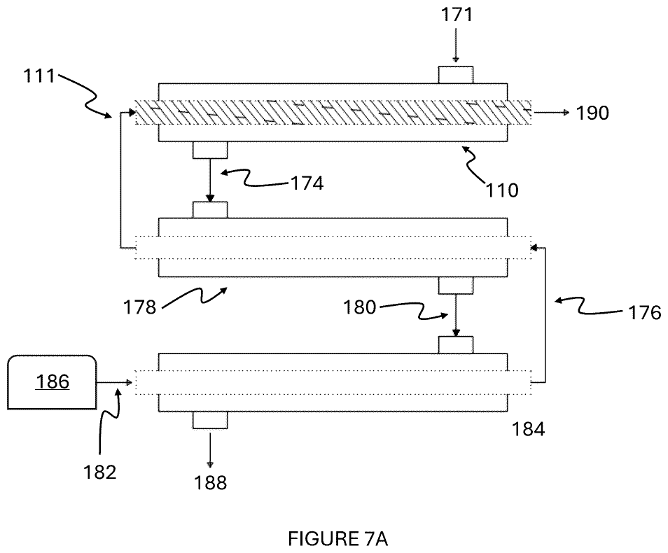

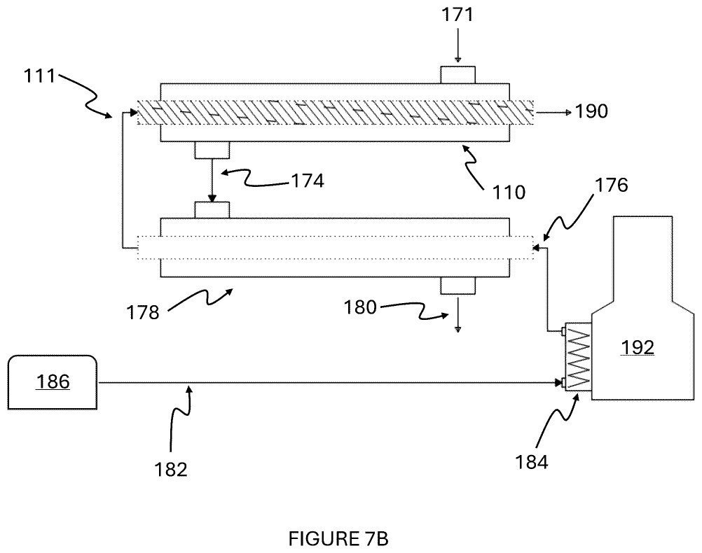

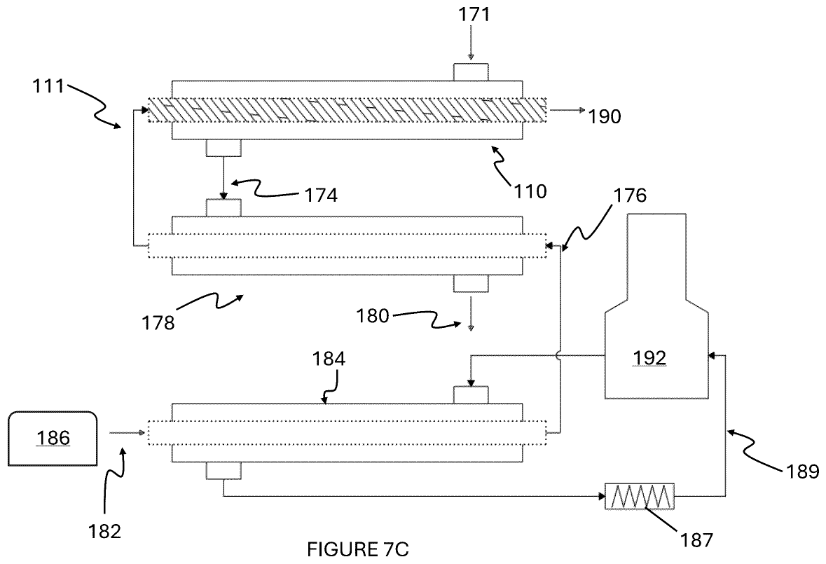

FIG. 7A illustrates an embodiment for heating the catalytic converter used to reform NH3 into a mixture of NH3 and H2 fuel. In this embodiment, exhaust stream 171 preferably flows through reformer 110, with reformer 110 configured as a heat exchanger where hot exhaust 171 transfers energy to NH3 gas 111, which has preferably been preheated as further described below. The heat transferred from exhaust stream 171 is preferably sufficient to provide the enthalpy of reaction required to maintain endothermic reaction 2. Exhaust stream 174, which is a partially cooled stream 171 exiting reformer 110, is preferably then used to preheat gaseous NH3 stream 176 in heat exchanger 178. Exhaust stream 180, which is a partially cooled stream 174 exiting heat exchanger 178, is then used to vaporize liquid NH3 stream 182 in vaporizer 184, with liquid NH3 delivered from fuel tank 186. Exhaust exits the system in stream 188 and NH3/H2 fuel exits in stream 190.

FIG. 7B illustrates another embodiment for heating the catalytic converter used to reform NH3 into a mixture of NH3 and H2 fuel. In this embodiment, exhaust stream 171 flows through reformer 110, with reformer 110 configured as a heat exchanger where hot exhaust 171 transfers energy to preheated NH3 gas 111. The heat transferred from exhaust stream 171 is preferably sufficient to provide the enthalpy of reaction required to maintain endothermic reaction 2. Exhaust stream 174, which is a partially cooled stream 171 exiting reformer 110, is then used to preheat gaseous NH3 stream 176 in heat exchanger 178. Prior to entering heat exchanger 178, liquid NH3 stream 182 flows through vaporizer 184 located on engine block 192, utilizing heat from the engine block to vaporize liquid NH3 stream 182 delivered from NH3 fuel tank 186. Exhaust exits the system in stream 180 and NH3/H2 fuel exits in stream 190.

FIG. 7C illustrates another embodiment for heating the catalytic converter used to reform NH3 into a mixture of NH3 and H2 fuel. In this embodiment, exhaust stream 171 flows through reformer 110, with reformer 110 configured as a heat exchanger where hot exhaust 171 transfers energy to preheated NH3 gas 111. The heat transferred from exhaust stream 171 is preferably sufficient to provide the enthalpy of reaction required to maintain endothermic reaction 2. Exhaust stream 174, which is a partially cooled stream 171 exiting reformer 110, is then used to preheat gaseous NH3 stream 176 in heat exchanger 178. Prior to entering heat exchanger 178, liquid NH3 stream 182 flows through vaporizer 184 which receives heat from coolant in engine cooling loop 189, used to remove heat from engine block 192. Remaining heat in engine coolant is removed through radiator 187 before returning to engine block 192. In this way heat from the engine cooling loop is used to vaporize liquid NH3 stream 182 delivered from NH3 fuel tank 186. Exhaust exits the system in stream 180 and NH3/H2 fuel exits in stream 190.

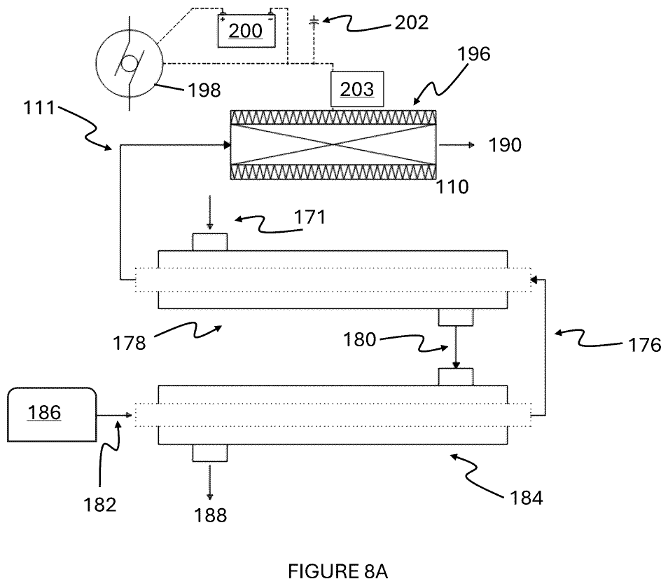

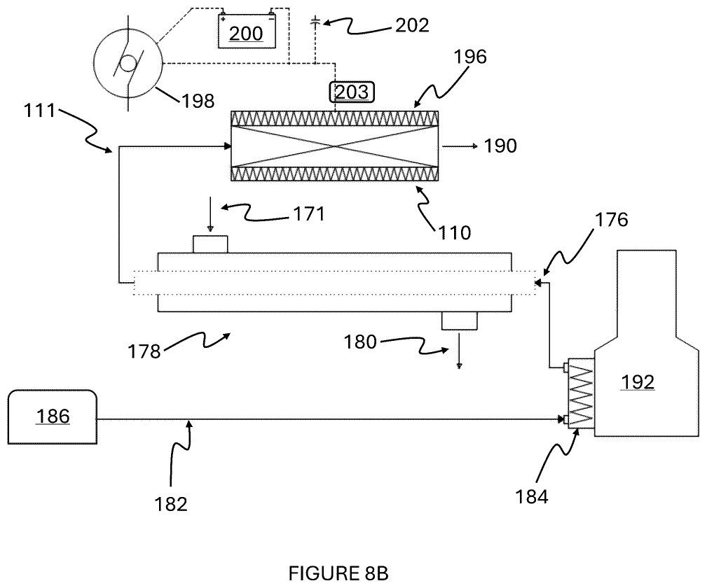

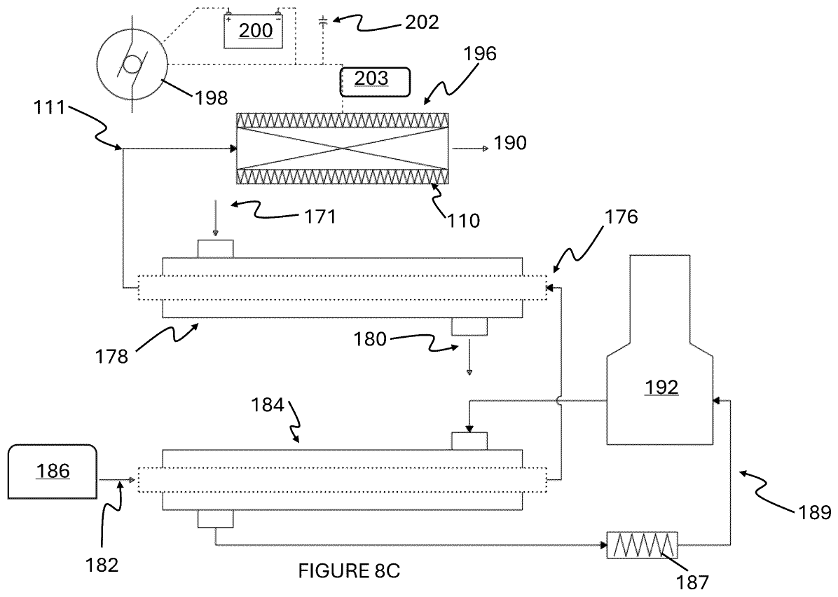

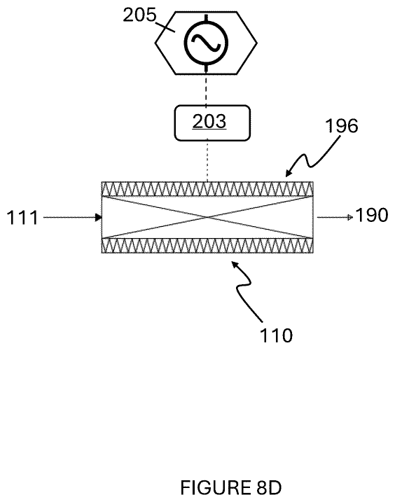

FIG. 8A illustrates an embodiment of the present invention that can be used for heating the catalytic converter used to reform NH3 into a mixture of NH3 and H2 fuel. In this embodiment, an electrical resistance heater 196 located outside or within reformer 110 is powered from power controller 203 fed from an alternator 198 powered from a pulley connected to the engine drive shaft, battery 200 charged from alternator 198, capacitor 202 charged from alternator 198, or a combination of two of these devices, or all three devices simultaneously. The heat provided from the resistance heater transfers energy to preheated NH3 gas 111. The heat transferred from resistance heater 196 is preferably sufficient to provide the enthalpy of reaction required to maintain endothermic reaction 2. Exhaust stream 171 is used to preheat gaseous NH3 stream 176 in heat exchanger 178. Exhaust stream 180, which is a partially cooled stream 171 exiting heat exchanger 178, is then used to vaporize liquid NH3 stream 182 in vaporizer 184, with liquid NH3 delivered from fuel tank 186. Exhaust exits the system in stream 188 and NH3/H2 fuel exits in stream 190.

FIG. 8B illustrates another embodiment of the present invention that can be used for heating the catalytic converter used to reform NH3 into a mixture of NH3 and H2 fuel. In this embodiment, an electric resistance heater 196, which can be located outside of or within reformer 110 is preferably powered from a power controller 203 fed from one or more of:
1) alternator 198,
2) battery 200,
3) capacitor 202, and/or
4) a combination thereof.
   Battery 200 and/or capacitor 202 are preferably at least partially charged by alternator 198, which itself can be powered from a pulley connected to the crank shaft, engine drive shaft, or another portion of the engine. The heat provided from the resistance heater transfers energy to preheated NH3 gas 111. The heat transferred from resistance heater 196 is preferably sufficient to provide the enthalpy of reaction required to maintain endothermic reaction 2. Exhaust stream 171 is preferably used to preheat gaseous NH3 stream 176 in heat exchanger 178. Prior to entering heat exchanger 178, liquid NH3 stream 182 preferably flows through vaporizer 184, which can be located on engine block 192, utilizing heat from the engine block to vaporize liquid NH3 stream 182 delivered from NH3 fuel tank 186. Exhaust exits the system in stream 180 and NH3/H2 fuel exits in stream 190.

FIG. 8C illustrates another embodiment of the present invention that can be used for heating the catalytic converter used to reform NH3 into a mixture of NH3 and H2 fuel. In this embodiment, a power controller 203 fed from one or more of:
1) alternator 198,
2) battery 200,
3) capacitor 202, and/or
4) a combination thereof.
   Battery 200 and/or capacitor 202 are preferably at least partially charged by alternator 198, which itself can be powered from a pulley connected to the crank shaft, engine drive shaft, or another portion of the engine. The heat provided from the resistance heater transfers energy to preheated NH3 gas 111. The heat transferred from resistance heater 196 is preferably sufficient to provide the enthalpy of reaction required to maintain endothermic reaction 2. Exhaust stream 171 is preferably used to preheat gaseous NH3 stream 176 in heat exchanger 178. Prior to entering heat exchanger 178, liquid NH3 stream 182 flows through vaporizer 184 which receives heat from coolant in engine cooling loop 189, used to remove heat from engine block 192. Remaining heat in engine coolant is removed through radiator 187 before returning to engine block 192. In this way heat from the engine cooling loop is used to vaporize liquid NH3 stream 182 delivered from NH3 fuel tank 186. Exhaust exits the system in stream 180 and NH3/H2 fuel exits in stream 190.

FIG. 8D illustrates another embodiment of the present invention that can be used for heating the catalytic converter 110 used to reform NH3 into a mixture of NH3 and H2 fuel using electrical resistance heater 196. In this embodiment, power controller 203 is fed from a source of alternating current 205 that is independent of the engine's electrical system, e.g., a standalone power generator, grid-supplied line source, or inverted power from a solar array or battery bank. Although in one embodiment, heater 196 is most preferably an electrical resistance heater, one or more other types of heaters can optionally be used instead of (or in addition thereto). For example, in one embodiment an inductive heater can be used to heat a ferromagnetic material that is in contact (or otherwise thermally coupled) to the NH3.

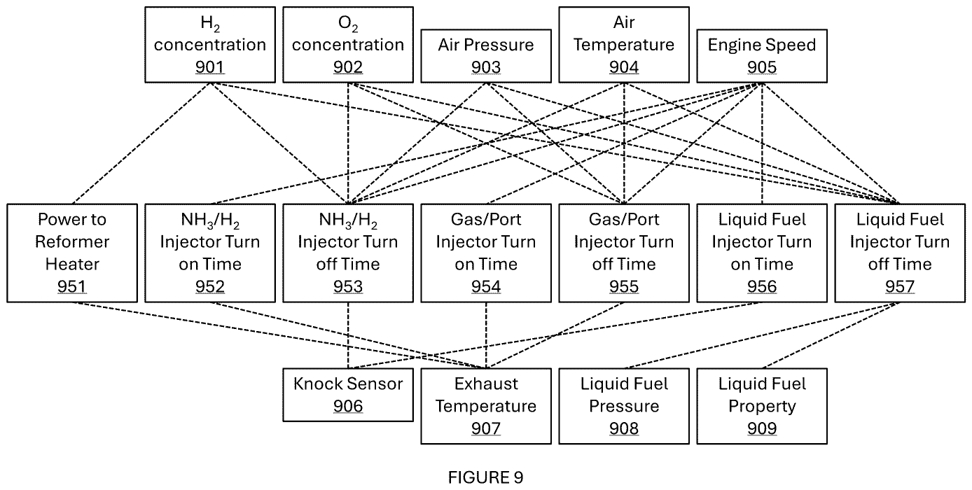

FIG. 9 is a block diagram illustrating the computer inputs from sensors that are preferably located on or about the CIE and the corresponding outputs to injectors and heaters. Dashed lines indicate the outputs impacted by the sensor inputs. One or more of these sensors can be used as an input for a control algorithm on a standalone controller used to generate H2 at a sufficient rate to satisfy engine demand.

H2 Sensor 901 preferably provides input regarding H2 content in the air/fuel mixture added to the combustion chamber and is used to modulate H2 production rate via reformer heater power 951 (for example, more power for more H2 and less power for less H2), the NH3/H2 fuel injector turn off time 953 (for example, delayed turn off time can result in more H2 added to air), and the liquid fuel injector turn off time 957 (for example, delayed turn off time results in more liquid fuel relative to NH3/H2 fuel added to the combustion cylinder).

O2 sensor 902 preferably provides input on O2 content in the CIE exhaust, which is an indicator of air used for combustion relative to excess air (for example, high O2 can suggest too much air in the combustion mixture). The O2 content can be used to modulate the NH3/H2 fuel injector turn off time 953 (for example, delayed turn off time results in a lower air to fuel ratio entering the combustion chamber), gas/port fuel injector turn off time 955 (for example, delayed turn off time can result in a lower air to fuel ratio entering the combustion chamber), and the liquid fuel injector turn off time 957 (for example, delayed turn off time results in a lower air to fuel ratio generated in the combustion chamber prior to ignition).

Air pressure sensor 903 preferably provides input on the pressure of combustion air in the intake pipe or manifold and air temperature sensor 904 provides input on the temperature of combustion air in the intake pipe or manifold. The temperature and pressure of air can be used to compute a molar flow rate of air and thus a molar flow rate of oxygen provided to the combustion chamber of the CIE. This allows modulation of the NH3/H2 fuel injector turn off time 953 (for example, turn off time can be used to meter proper NH3/H2 fuel content to meet a desired air to fuel ratio), gas/port fuel injector turn off time 955 (for example, turn off time used to meter proper gas/port fuel content to meet a desired air to fuel ratio), and the liquid fuel injector turn off time 957 (for example, turn off time can be used to meter liquid fuel to meet a desired net air to fuel ratio generated in the combustion chamber prior to ignition).

Engine speed sensor 905 preferably provides information on the cycle rate of the CIE (for example in revolutions per minute), which dictates NH3/H2 injector 952 turn on time, gas/port injector 954 turn on time, and liquid fuel injector 956 turn on time with subsequent information by other sensors 901, 902, 903, 904, 905, 906, 907, 908, and 909 dictating NH3/H2 injector turn off time 953, gas/port injector turn off time 955, and//or liquid fuel injector turn off time 957.

Knock sensor 906 preferably provides feedback on pre-ignition (for example, ignition at undesired timing in the air/fuel delivery and compression cycle) and allows modulation of the amount of H2 delivered via NH3/H2 injector turn off time 953 and the timing of liquid fuel entry via liquid fuel injector turn on time 956.

Exhaust temperature sensor 907 preferably provides an indication of the engine operating temperature and availability of heat to perform NH3 heating and reforming to produce H2. When temperatures are low, a preheating period may be required at reformer heater 951 before reformer 110 achieves proper operating temperature and non-NH3 derived fuel may be needed to start the engine and bring it to operating temperature. When a non-NH3 derived fuel is available for injection at port injector 120, operation with NH3/H2 mixtures may be delayed while exhaust temperature sensor 907 indicates insufficient temperature for NH3 reforming or preheating. In this transient situation, more fuel will be provided by activating gas/port injector turn on events (times) 954 and setting gas/port injector turn off time 955 to ensure sufficient non-NH3 derived fuel to operate the CIE and bring it to steady operating temperature. When engine temperature is sufficiently hot temperature sensor 907 can inform the control computer that NH3/H2 can be injected by enabling NH3/H2 injector turn on time 952 and can disable gas/port fuel turn on time 954 or reduce gas/port fuel injected by changing turn off time 955.

Liquid fuel pressure sensor 908 preferably provides information about the force driving fuel through the liquid fuel injector and thus the turn off time 957 required to inject a preferred quantity of liquid fuel. In a similar way, liquid fuel property 909 is a sensor that provides information on the type of liquid fuel being delivered (e.g., diesel, NH3, liquefied natural gas, methanol) via a property, which can include for example one or more sensors that detect or otherwise measure density, capacitance, conductivity, or some other property of the fuel, which allows the control computer to determine the turn off time 957 to achieve the desired delivery of liquid fuel in each injection.

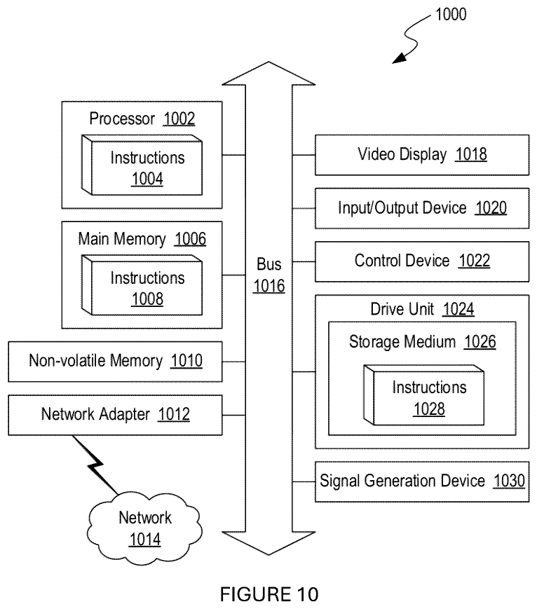

FIG. 10 is a block diagram illustrating an example computer system 1000. In one embodiment, components of the example computer system 1000 are used to implement and/or control the processes described herein. At least some operations described herein can be implemented on the computer system 1000. Computer system 1000 can optionally be the computer system used to control the engine (i.e., the engine control unit or ECU) or it can be a stand-alone computer system used to control the on-demand hydrogen production apparatus. Computer system 1000 can also comprise two separate computer systems that communicate with one another—for example with one of the computers receiving signals, data and instruction from the other computer, and with one of the computers used to control the engine and the other computer used to control the on-demand hydrogen production apparatus.

Computer system 1000 can include one or more central processing units (“processors”) 1002, main memory 1006, non-volatile memory 1010, network adapters 1012 (e.g., network interface), video displays 1018, input/output devices 1020, control devices 1022 (e.g., keyboard and pointing devices), drive units 1024 including a storage medium 1026, and a signal generation device 1030 that are communicatively connected to a bus 1016. Bus 1016 is illustrated as an abstraction that represents one or more physical buses and/or point-to-point connections that are connected by appropriate bridges, adapters, or controllers. Bus 1016, therefore, can include a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus (also referred to as “Firewire”). Input/Output Device 1020 includes connections to all sensors in FIG. 9 and all sensors otherwise involved in the operation of the CIE, connected via one or more wiring harnesses into Bus 1016.

Computer system 1000 can share a similar computer processor architecture as that of a desktop computer, tablet computer, personal digital assistant (PDA), mobile phone, game console, music player, wearable electronic device (e.g., a watch or fitness tracker), network-connected (“smart”) device (e.g., a television or home assistant device), virtual/augmented reality systems (e.g., a head-mounted display), or another electronic device capable of executing a set of instructions (sequential or otherwise) that specify action(s) to be taken by computer system 1000.

While the main memory 1006, non-volatile memory 1010, and storage medium 1026 (also called a “machine-readable medium”) are illustrated as a single medium, the term “machine-readable medium” and “storage medium” should be taken to include a single medium or multiple media (e.g., a centralized/distributed database and/or associated caches and servers) that store one or more sets of instructions 1028. The term “machine-readable medium” and “storage medium” shall also be taken to include any medium that is capable of storing, encoding, or carrying a set of instructions for execution by computer system 1000.

In general, the routines executed to implement the embodiments of the present invention can be implemented as part of an operating system or a specific application, component, program, object, module, or sequence of instructions (collectively referred to as “computer programs”). The computer programs typically include one or more instructions (e.g., instructions 1004, 1008, 1028) set at various times in various memory and storage devices in a computer device. When read and executed by one or more processors 1002, the instruction(s) cause the computer system 1000 to perform operations to execute elements involving the various aspects of embodiments of the invention.

Network adapter 1012 preferably enables computer system 1000 to mediate data in a network 1014 with an entity that is external to the computer system 1000 through any communication protocol supported by the computer system 1000 and the external entity. Network adapter 1012 can include a network adapter card, a wireless network interface card, a router, an access point, a wireless router, a switch, a multilayer switch, a protocol converter, a gateway, a bridge, a bridge router, a hub, a digital media receiver, and/or a repeater.

Network adapter 1012 can include a firewall that governs and/or manages permission to access proxy data in a computer network and tracks varying levels of trust between different machines and/or applications. The firewall can be any number of modules having any combination of hardware and/or software components able to enforce a predetermined set of access rights between a particular set of machines and applications, machines and machines, and/or applications and applications (e.g., to regulate the flow of traffic and resource sharing between these entities). The firewall can additionally manage and/or have access to an access control list that details permissions including the access and operation rights of an object by an individual, a machine, and/or an application, and the circumstances under which the permission rights stand.

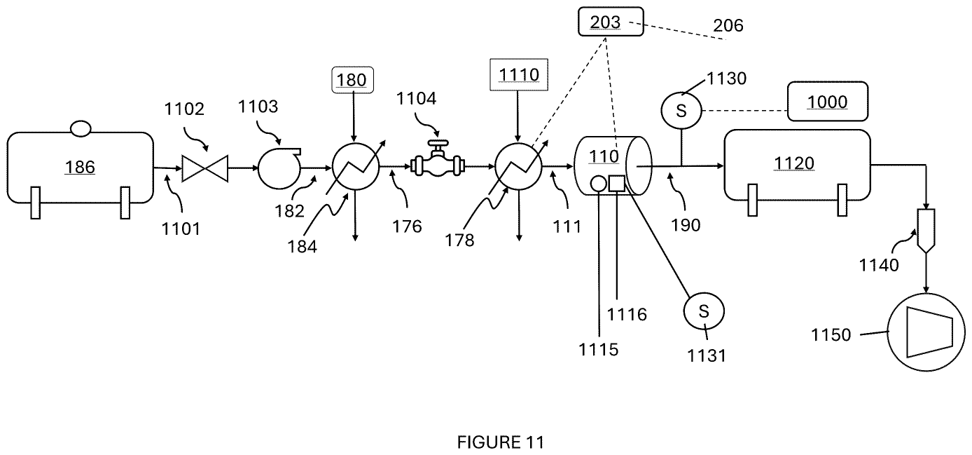

FIG. 11 shows an embodiment of the present invention where an on-demand H2 delivery system is provided as a standalone apparatus that can be added to an existing engine 1150. Tank 186, compatible with the fluid with chemically-bound hydrogen used as the H2 source, is provided with fluid connection 1101 and shutoff valve 1102, which allows liquid fluid stream 182 to enter heat exchanger 184, which serves to vaporize fluid 182 using hot fluid 180, which can be supplied from any desired source, resulting in gaseous fluid 176. Optional pump 1103 provides an increase in pressure to liquid fluid 182 to push it through the apparatus. Control valve 1104 opens and closes to modulate the flow of gaseous fluid 176 into the catalytic reformer. Gaseous fluid 176 flows into optional heat exchanger 178, which serves to superheat gaseous fluid 176 to produce superheated fluid 111. Optional heat exchanger 178 can be heated by exchange with hot reformer effluent 190, engine exhaust 171, user-supplied hot fluid 1110, or by electrical resistance heating controlled by heater controller 203. Superheated fluid 111 flows into reformer 110, which is one or a multiplicity of electric heaters 1115 controlled by one or a multiplicity of power controllers 203 with input from one or more sensors 1131, and one or a multiplicity of catalyst-containing passages 1116. Electricity can be supplied through wires 206. Reformed fluid containing H2 and anywhere from about 0 to about 80 percent of unreacted fluid containing chemically-bound hydrogen flows into optional accumulation vessel 1120. One or more sensors 1130 can optionally include one or more pressure sensors, temperature sensors, and/or fluid composition sensors, which can provide one or more inputs to computer system 1000, which provides outputs to optional pump 1103, control valve 1104, and power controllers 203 to maintain a pressure of H2 downstream of reformer 110. H2 introduction device 1140 preferably connects to the air intake of the engine and is actuated from signals sent from the engine control unit.

In some embodiments the engine control computer communicates signals on the status and values of the engine's sensors to the stand alone H2 production system, and in other embodiments, the H2 production system operates independently of the end-user's engine controller.

In one embodiment, a mixture of ammonia gas (NH3,g), hydrogen gas (H2) and nitrogen gas (N2) are mixed with combustion air in the air intake pipe or manifold of a compression ignition engine (CIE) prior to delivery of an air/NH3,g/H2/N2 mix to a combustion chamber within the CIE. This will be referred to as port injection of NH3,g or NH3,g/H2/N2 fuel.

In one embodiment, NH3,g is partially reformed to a mixture of NH3,g, H2, and N2 by use of a catalytic reformer placed between an NH3 feed tank and the air intake pipe or manifold of a CIE. In one embodiment, an NH3,g/H2/N2 mix is metered into the intake air stream by use of an electronic gas injection device connected to a control computer. In one embodiment, an NH3,g/H2/N2 mix is further mixed with air using a gas mixing device located between the air and NH3,g/H2/N2 mix entry points and the inlet of the combustion chamber. In one embodiment, the air in the intake stream is pressurized by a turbocharger or supercharger. In one embodiment, a portion of the exhaust stream from a CIE is directed to the air intake pipe or manifold of the CIE. This will be referred to as exhaust gas recirculation (EGR). In one embodiment, the extent of reforming of NH3,g to H2 and N2 is adjusted to vary the ratio of NH3,g and H2 delivered to the air intake pipe or manifold based on the CIE speed and load. In one embodiment, the extent of reforming of NH 3,g to H2 and N2 is preferably greater than 80% and more preferably greater 90%, and most preferably greater than 95%.

In one embodiment, the extent of reforming of NH3,g to H2 and N2 is controlled by adjusting the flow rate of NH3,g to a catalytic fuel reformer and/or by adjusting the temperature of a catalytic fuel reformer. In one embodiment, the CIE receives a portion of its fuel energy via port injection of NH3,g/H2/N2 mixtures and the remaining required fuel energy via direct injection of a liquid fuel consisting of one or more of diesel, fuel oil, NH3, methane (LNG), liquefied petroleum gas (LPG), or methyl alcohol. In one embodiment, the CIE receives a portion of its fuel energy via port injection of H2 derived from a fluid containing chemically-bound hydrogen via catalytic reforming and the remaining required fuel energy via direct injection of a liquid fuel consisting of one or more of diesel, fuel oil, NH3, methane, liquified natural gas (“LNG”), liquefied petroleum gas (“LPG”), or methyl alcohol. In one embodiment, the CIE receives all of its fuel energy via port injection of NH3,g/H2/N2 mixtures or separate (additive) port injections of NH3,g/H2/N2 mixtures and a hydrocarbon fuel consisting of diesel, fuel oil, methane, LPG, or methyl alcohol. In one embodiment, the CIE receives all of its fuel energy via port injection of H2 derived from a fluid containing chemically-bound hydrogen via catalytic reforming and separate (additive) port injections of fuel, which can include one or more of diesel, fuel oil, methane, LNG, LPG, NH3, or methyl alcohol. In one embodiment, fuel is delivered to the CIE via port injection of gaseous fuel and direct injection of liquid fuel according to a computer program that matches fuel demand and fuel quality with intake air flow, temperature, and pressure, and engine speed and load.

In one embodiment, sensible heat present in CIE exhaust is used to partially or fully provide the heat required to vaporize a fluid containing chemically-bound hydrogen and to partially reform this fluid to derive H2. In one embodiment, an alternator powered by the CIE is used to provide electricity to power electrical heating elements to provide some or all heat required to vaporize a fluid containing chemically-bound hydrogen and to partially reform this fluid to derive H2. In one embodiment, a capacitor and/or battery charged from an alternator powered by the CIE is used to provide electricity to power resistive heating elements to provide some of the heat required to a fluid containing chemically-bound hydrogen and to partially reform this fluid to derive H2. In one embodiment, a source of electricity separate from the engine's electrical system provides electricity to power electrical heating elements to provide some or all of the heat required to fully or partially reform a fluid containing chemically-bound hydrogen to derive H2.

In one embodiment, an H2 sensor placed in the fuel stream downstream of the reformer provides information to the CIE control computer to determine appropriate injection volumes and timings for port fuel injection to satisfy engine speed and load demand. In one embodiment, an H2 sensor placed in the fluid stream downstream of the reformer provides information to a standalone control computer to determine appropriate flow of a fluid containing chemically-bound hydrogen and electrical power to deliver to a catalytic reformer. In one embodiment, an oxygen (O2) sensor placed in the exhaust stream of the CIE provides information to the CIE control computer to determine appropriate injection volumes and timing for port fuel injection to satisfy engine speed and load demand. In one embodiment, an NH3 sensor placed in the exhaust stream of the CIE provides information to the CIE control computer to determine appropriate injection volumes and timing for port fuel injection to satisfy engine speed and load demand. In one embodiment, a pressure sensor placed in the inlet air pipe or manifold of a CIE provides information to the CIE control computer to determine appropriate injection volumes for port fuel injection to maximize power delivered to the CIE and to control the air to fuel ratio that reaches the cylinders of the CIE.

In one embodiment, the combination of sensory input from O2, NH3, H2, pressure, temperature, and knock sensors are combined with operator input to a control computer, allowing the control computer to operate the CIE from multiple fuel types (flex fuel) including different fuels added via port injection and direct injection and fuel combined in separate or mixed port or direct injections.

In one embodiment, sensory input from one or a combination of O2, NH3, H2, pressure, temperature, and knock sensors, integrated with an engine, are used with a standalone computer to control the flow of a fluid containing chemically-bound hydrogen and electrical power delivered to a catalytic reformer. In one embodiment, sensory input from one or a combination of NH3, H2, pressure, and temperature sensors, not connected to an engine control computer, are combined with operator input of H2 demand and concentration for a standalone control computer to control the flow of a fluid containing chemically-bound hydrogen and electrical power delivered to a catalytic reformer.

Embodiments of the present invention relate to a fuel delivery system for engines having a flow path for a fuel stream which itself has first tubes, conduits, passages, and/or channels, a fuel stream that includes NH3 and H2, a fuel stream that includes H2 and N2, and a catalytic reformer to decompose a stream of NH3 to a mixture of NH3 and H2 and N2 or a mixture of H2 and N2; and an injector to introduce the fuel stream into engine intake air; an H2 sensor; and an injector positioned and configured to deliver liquid fuel to the combustion chamber of the engine. In one embodiment, a third injector can be positioned to introduce additional fuel into engine intake air. At least one injector is preferably located within the engine air intake to deliver a mixture of NH3 and H2 and N2 or H2 and N2 derived from catalytic reforming of a fluid containing chemically-bound hydrogen. Greater than 1% of the total energy contained in the fuel is preferably derived from the H2, which itself is derived from catalytic reforming of a fluid containing chemically-bound hydrogen. The introduction of H2 derived by reformed NH3 or any other fluid containing chemically-bound hydrogen preferably allows the delivery of as many as 3 different liquid or gaseous fuels to an engine or mixtures of different fuels without requiring changes to the mechanical components of the engine, the location of fuel injectors, or the location or type of sensors.

Embodiments of the present invention also relate to a fuel delivery control algorithm that includes inputs from sensors that include H2 content in intake air, O2 content in exhaust, engine speed, intake air pressure and temperature or density, and a liquid fuel physical property, and outputs to fuel injectors. The outputs to fuel injectors can include H2 fuel injector turn on time and duration, additional port fuel injector turn on time and duration, direct fuel injector turn on time and duration, and electrical power delivery to a catalytic reformer. The control algorithm can be interpreted and executed automatically with a control computer. Additional instructions can be delivered to the control computer by an operator, a subroutine, and/or an interlock. The H2 content in air can be determined by calculation from a measurement of the fluid containing chemically-bound hydrogen concentration exiting the catalytic reformer.

In one embodiment, the present invention can be provided as a drop-in unit to retrofit onto existing CIEs. Optionally, however, CIEs can be constructed from the ground up and can incorporate embodiment of the present invention. Embodiments of the present invention can be incorporated into CIEs that are mobile or stationary—including but not limited to generators, pumping stations, ships, vehicles, heavy equipment, which can optionally include mining, construction and rail locomotives and equipment, and the like.

### Industrial Applicability

The invention is further illustrated by the following non-limiting hypothetical examples of possible applications for implementation of the present invention.

### Example 1

A four-cycle CIE can be used to produce power at drive shaft 153 to rotate an electrical generator used to power a refrigeration cycle. It can be configured to consume NH3 as a primary fuel and diesel as a secondary fuel (i.e., greater than 50% of the fuel energy can be derived from NH3). The engine can be started from a cold and idle state using only diesel fuel injected through direct injector 130 and air delivered through intake manifold 102. When the engine exhaust reaches steady temperature, NH3 flow can start to reformer 110, which can be heated from engine exhaust, resulting in catalytic conversion of 40% of the NH3 to H2 and N2 gases. NH3/H2 gas can be injected via port injector 113 while fuel delivery through direct injector 130 can be reduced to maintain the same air to fuel ratio. Additional NH3 can be added by blending liquid NH3 into the diesel stream injected at direct injector 130, with additional H2 delivered through port injector 113. Liquid fuel pressure sensor 908 and liquid fuel property sensor(s) 909 along with engine speed sensor 905 can provide information to computer system 1000 to dictate the injector turn on and turn off timing to achieve a proper air to fuel ratio as diesel is preferably replaced with NH3 and H2. H2 sensor 901 preferably provides information to computer system 1000 to dictate the amount of NH3 that can be injected in lieu of diesel, i.e., the amount of ignition and flame speed assistance available to consume larger amounts of NH3 fuel.

### Example 2

The four-cycle CIE of example 1 can be operated for the same purpose as example 1 but the NH3 reformer can instead be heated via resistive element heater. The engine, when started from cold as described in example 1, and once started, a portion of electricity generated by the electrical generator can be used to heat reformer 110. Because heat generation can be nearly instantaneous, delivery of NH3/H2 fuel to port injector 113 can be started before the engine has reached steady operating temperature, thus reducing the amount of diesel fuel consumed on startup. Diesel can be slowly replaced with NH3 as described in example 1.

### Example 3

The four-cycle CIE of example 2 can be running on NH3 and diesel fuels and if the operator desires to switch to a compressed natural gas fuel instead of diesel, while maximizing the amount of NH3 used for power generation, the operator can reduce the ratio of NH3 to diesel delivered through direct injector 130 while providing compressed natural gas to port injector 120. Computer system 1000 preferably recomputes injection timings for injector 120 and 130 based on the reduced amount of diesel and availability of compressed natural gas to form a proper air to fuel ratio given information from H2 sensor 901, O2 sensor 902, air pressure and temperature sensors 903 and 904, engine speed sensor 905, liquid fuel pressure sensor 908, and liquid fuel property sensor 909. As diesel fueling can be decreased toward zero, control computer 1000 preferably responds to a demand for more H2 at H2 sensor 901 by providing more power to reformer heater 951 and by increasing the amount of NH3/H2 injected at port injector 113 and/or by decreasing the amount of NH3 delivered through direct injector 130 optionally, this can optionally be done by increasing the amount of compressed natural gas delivered through port injector 120.

### Example 4

A four-cycle CIE can be used to power a boat or piece of heavy equipment operating with variable loads and fuels. The equipment can be fitted with tanks that hold liquid diesel, fuel oil, or methanol, liquefied NH3, and liquefied natural gas. It can be desired to consume the fuel that is most available at the time, smaller amounts of the other fuels can be used as necessary to ensure smooth engine operation. The engine can be assumed to be at operating temperature. The engine can be equipped with an alternator driven by belts connected to the drive shaft by pulleys, which charge a bank of 12V batteries when their voltage falls below a threshold value and which spin without load when the voltage reaches an upper threshold. An NH3 reformer can be heated via resistance heaters connected to the 12V battery bank, with power modulated by a solid-state relay connected to a control computer. Liquid fuels can be manifolded to a central fuel line and pump and can be metered into the central line with variable position valves controlled by computer with input on desired fuel blends from an operator (i.e., operator selected most available fuel as primary energy source). A capacitance gauge can be located on the central fuel line and can be calibrated to determine fuel ratios based on the capacitances of pure fuels and fuel mixtures. The capacitance gauge can be provided a signal which the control computer interprets as fuel energy per volume. As the operator changes the mix of available fuels, the liquid fuel blends are preferably delivered to the engine via direct injection. The control computer calculates the required H2 for proper combustion of the liquid fuels and adjusts the power to the NH3 reformer to generate more or less H2. The control computer also calculates the proper turn on and turn off times of the NH3/H2 port injector and liquid fuel direct injector to generate the proper fuel/H2 ratios and air/fuel ratios for efficient combustion and power transfer.

From the foregoing, it will be appreciated that the disclosed embodiments have been described herein for purposes of illustration, but that various modifications can be made without deviating from the scope of the disclosed embodiments. Accordingly, the disclosed embodiments are not limited.

For clarity, when referring to “reforming” of NH3 to liberate H2, such reforming can include cracking the NH3 to liberate the H2. In the various embodiments described herein, the electrically-powered heater can optionally be replaced with a heater that is powered from another energy source. In one embodiment, the heater that is powered from another energy source is preferably a heater which is electrically controllable. Accordingly, in one embodiment, the output of the controller can be used to adjust the output of the heater for embodiments wherein the heater is not powered by electricity but which is controllable by an electrical signal, voltage and/or current.

In one embodiment, the system and method of the present invention can be used to provide supplemental hydrogen to an engine during all phases of the engine's operation and is not limited to only providing hydrogen during startup or shortly thereafter. Embodiments of the present invention can dynamically provide a supply of hydrogen gas to the air intake of the vehicle, optionally without modifying or otherwise adjusting the operation of the engine itself. For example, in one embodiment the present invention can dynamically provide a supply of hydrogen gas to the engine without the need to adjust the timing of the engine. Optionally, hydrogen gas can be provided directly to the air intake of the engine without the need to first mixing the hydrogen with air in a pre-mixing chamber—accordingly, in one embodiment a pre-mixing chamber is not provided. Optionally, hydrogen can be introduced into the intake air before it enters into the engine block thereof, accordingly, in one embodiment, dedicated hydrogen injectors do not need to be provided on any one or more of the cylinders.

Unless otherwise indicated, all number or expressions, such as those expressing dimensions, physical characteristics, etc., used in the specification (other than the claims) are understood as modified in all instances by the term “approximately”. Moreover, all ranges disclosed herein are to be understood to encompass and provide support for claims that recite any and all sub-ranges or any and all individual values subsumed therein.

The preceding examples can be repeated with similar success by substituting the generically or specifically described components and/or operating conditions of embodiments of the present invention for those used in the preceding examples. The functions performed in the processes and methods can be implemented in differing order. Furthermore, the outlined steps and operations are only provided as examples, and some of the steps and operations can be optional, combined into fewer steps and operations, or expanded into additional steps and operations without detracting from the essence of the disclosed embodiments. Some functions were described by way of example in FIG. 9 and associated descriptions.

The description and drawings herein are illustrative and are not to be construed as limiting. Numerous specific details are described to provide a thorough understanding of the disclosure. Further, various modifications can be made without deviating from the scope of the embodiments.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms can be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way. One will recognize that “memory” is one form of a “storage” and that the terms can on occasion be used interchangeably. Consequently, alternative language and synonyms can be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any term discussed herein, is illustrative only and is not intended to further limit the scope and meaning of the disclosure or of any exemplified term. Likewise, the disclosure is not limited to various embodiments given in this specification.

Optionally, embodiments of the present invention can include a general or specific purpose computer or distributed system programmed with computer software implementing steps described above, which computer software can be in any appropriate computer language, including but not limited to C, C++, FORTRAN, BASIC, Java, Python, Linux, assembly language, microcode, distributed programming languages, etc. The apparatus can also include a plurality of such computers / distributed systems (e.g., connected over the Internet and/or one or more intranets) in a variety of hardware implementations. For example, data processing can be performed by an appropriately programmed microprocessor, computing cloud, Application Specific Integrated Circuit (ASIC), Field Programmable Gate Array (FPGA), or the like, in conjunction with appropriate memory, network, and bus elements. One or more processors and/or microcontrollers can operate via instructions of the computer code and the software is preferably stored on one or more tangible non-transitive memory-storage devices.

As used throughout this application, the terms, “a”, “an”, “the”, and “said” mean “one or more” unless context explicitly dictates otherwise. Note that in the specification and claims, “about”, “approximately”, and/or “substantially” means within twenty percent (20%) of the amount, value, or condition given. All computer software disclosed herein can be embodied on any non-transitory computer-readable medium (including combinations of mediums), including without limitation hard drives (local or network storage device), USB keys, other removable drives, ROM, firmware, or any other media or device for storing data and/or software.

Embodiments of the present invention can include every combination of features that are disclosed herein independently from each other. Although the invention has been described in detail with particular reference to the disclosed embodiments, other embodiments can achieve the same results. Variations and modifications of the present invention will be obvious to those skilled in the art and this application is intended to cover, in the appended claims, all such modifications and equivalents. The entire disclosures of all references, applications, patents, and publications cited above and/or in the attachments, and of the corresponding application(s), are hereby incorporated by reference. Unless specifically stated as being “essential” above, none of the various components or the interrelationship thereof are essential to the operation of the invention. Rather, desirable results can be achieved by substituting various components and/or reconfiguration of their relationships with one another.

What is claimed is:

1. A flex fueling apparatus comprising:
a fluid container;
a heat exchanger communicably coupled to said fluid container and configured to increase a temperature of a fluid containing chemically-bound hydrogen by using a fluid from a system associated with an engine;
a catalytic reformer in fluid communication with said fluid container, said catalytic reformer comprising a solid phase catalyst selected to reform the fluid containing chemically-bound hydrogen and liberate the hydrogen;
a heater positioned to supply heat to an endothermic reforming reaction that liberates the hydrogen from the fluid containing chemically-bound hydrogen;
a source of energy;
a controller configured to control said heater;
electromechanical hardware configured to adjust and/or control a flow of the liberated hydrogen that is produced by said catalytic reformer; and
an electromechanical apparatus configured to control a flow of the liberated hydrogen to an air intake system of an engine.

2. The heater of claim 1 wherein said heater comprises an electrical heater and wherein said source of energy comprises a source of electrical power and wherein said controller is configured to control power delivered to said electrical heater.

3. The flex fueling apparatus of claim 1 further comprising at least some of the fluid containing chemically-bound hydrogen is disposed within said fluid container, and wherein the fluid containing chemically-bound hydrogen comprises at least ninety percent by weight of an element selected from the list consisting of ammonia, urea, methanol, ethanol, natural gas, and a combination thereof.

4. The flex fueling apparatus of claim 1 wherein said heat exchanger is further communicably coupled to an element selected from a list consisting of an engine coolant system, an engine exhaust system, and a reformer effluent system.

5. The flex fueling apparatus of claim 1 wherein said heater is positioned to physically contact the fluid containing chemically-bound hydrogen and to physically contact the liberated hydrogen gas.

6. The flex fueling apparatus of claim 2 wherein said electrical heater is communicably coupled to at least one of a single phase alternating current source and a three-phase alternating current source.

7. The flex fueling apparatus of claim 6 wherein said controller is configured to reduce a voltage of the at least one of the single phase alternating current source and the three-phase alternating current source.

8. The flex fueling apparatus of claim 2 further comprising at least one of a battery and a capacitor coupled and configured to store electrical power and wherein said controller is configured to control power delivered to said electrical heater from said at least one of said battery and said capacitor.

9. The flex fueling apparatus of claim 1 wherein said electromechanical hardware comprises a combination of at least four elements selected from the list consisting of:
a shutoff valve configured to turn on and/or off a flow of the fluid containing chemically-bound hydrogen;
a pump configured to increase the flow and/or a pressure of the fluid containing chemically-bound hydrogen to said catalytic reformer;
a control valve configured to increase or decrease the flow of the fluid containing chemically-bound hydrogen to said catalytic reformer;
a shutoff valve configured to allow and/or disallow a flow of inert gas into said fluid container;
a pressure sensor positioned to sense a pressure of the liberated hydrogen;
a composition sensor configured to sense a fraction of hydrogen gas contained in fluid exiting said catalytic reformer;
a composition sensor configured to sense a fraction of fluid containing chemically-bound hydrogen remaining in the fluid exiting said catalytic reformer; and
an accumulation volume sensor that determines an accumulation volume of the liberated hydrogen, which accumulation volume does not include the liberated hydrogen that has already been withdrawn therefrom for delivery to the engine.

10. A method of retrofitting an engine to allow flex fueling with a portion of hydrogen gas, the method comprising installing:
a container designated for fluid containing chemically-bound hydrogen;
a heat exchanger configured to increase a temperature of the fluid containing chemically-bound hydrogen, the heat exchanger coupled to receive a fluid from a system associated with the engine;
a catalytic reformer configured to liberate hydrogen gas from fluid containing chemically-bound hydrogen;
a heater configured to supply heat to an endothermic reforming reaction that liberates the hydrogen gas from the fluid containing chemically-bound hydrogen;
a controller configured to control the heater;
a control computer configured to receive input signals and send output signals to control devices;
a wire connected to an output terminal of the control computer;
electromechanical hardware to control a flow of the liberated hydrogen gas from the catalytic reformer; and
an electromechanical apparatus, the electromechanical apparatus configured to periodically and/or adjustably allow a flow of the hydrogen gas to enter an air intake system of the engine.

11. The method of claim 10 wherein installing the heater comprises installing an electrical heater and wherein installing the controller comprises installing a power controller configured to control power delivered to the electrical heater.

12. A method for providing supplemental hydrogen to assist combustion of another fuel in an engine, the method comprising:
providing a supply of a fluid containing a chemically-bound hydrogen from a storage tank;
pre-heating the fluid containing a chemically-bound hydrogen with a heat exchanger, the heat exchanger coupled and configured to receive a flow of an engine system fluid having a temperature greater than an internal temperature of the storage tank;
providing heat from a heater to an endothermic reforming reaction that liberates the hydrogen from the fluid containing chemically-bound hydrogen;
passing the pre-heated fluid containing a chemically-bound hydrogen into a catalytic reformer, such that the fluid containing a chemically-bound hydrogen contacts a catalyst and reforms the fluid containing a chemically-bound hydrogen to liberate hydrogen gas;
collecting the liberated hydrogen gas; and
dynamically controlling a flow of the liberated hydrogen gas into an air intake system of the engine.

13. The method of claim 12 wherein providing heat from a heater comprises providing heat from an electrical heater.

14. The method of claim 12 further comprising dynamically controlling the liberation of hydrogen gas by a combination of at least three elements selected from the list consisting of: turning on and/or off a flow of the fluid containing the chemically-bound hydrogen with a shutoff valve, increasing the flow and/or a pressure of the fluid containing a chemically-bound hydrogen to the catalytic reformer with a pump, adjusting the flow of the fluid containing chemically-bound hydrogen to the catalytic reformer; using a shutoff valve to allow and/or disallow a flow of inert gas into the fluid container; using a pressure sensor to sense a pressure of the liberated hydrogen; sensing a fraction of hydrogen gas contained in fluid exiting said catalytic reformer; sensing a fraction of the fluid containing chemically-bound hydrogen remaining after exiting the catalytic reformer; and determining an accumulation volume of the liberated hydrogen, which accumulation volume does not include the liberated hydrogen that has already been withdrawn therefrom for delivery to the engine.

15. The method of claim 12 wherein providing heat from a heater to an endothermic reforming reaction comprises further heating the fluid with the heater.

16. The method of claim 12 wherein providing heat from a heater comprises providing heat from a heater which is powered by a source that does not comprise the engine.

17. The method of claim 13 wherein providing heat from a heater comprises providing heat from an alternating current electrical heater which is powered by a generator.

18. The method of claim 17 wherein the alternating current is single phase.

19. The method of claim 17 wherein the alternating current is three-phase.

20. The method of claim 12 wherein providing a supply of a fluid containing a chemically-bound hydrogen comprises providing a liquid supply of the fluid containing a chemically-bound hydrogen from the storage tank.

21. The method of claim 20 further comprising heating to vaporize the liquid supply of the fluid containing a chemically-bound hydrogen before the step of pre-heating the fluid containing a chemically-bound hydrogen with a heat exchanger.

22. The method of claim 21 wherein heating to vaporize comprises heating to vaporize with a vaporizing heat exchanger that receives heat energy produced by the engine.

23. The method of claim 22 wherein the heat produced by the engine comprises heat from an exhaust of the engine.

24. The method of claim 12 wherein providing heat from a heater comprises providing heat from a direct-current electrically-powered heater and wherein the direct-current is stored in at least one of a battery and a capacitor.

25. The method of claim 24 wherein the battery or capacitor receives electrical energy that is produced by an alternator or generator that is part of or is otherwise coupled to the engine.

26. The method of claim 12 wherein providing a supply of a fluid containing a chemically-bound hydrogen from a storage tank comprises providing a supply of ammonia.

27. The method of claim 12 wherein dynamically controlling a flow of the liberated hydrogen gas comprises dynamically controlling based on a load on the engine.
